(19) United States
(12) Patent Application Publication
(10) Pub. No.: US 2013/0226649 A1
(43) Pub. Date: Aug. 29, 2013

(54) Methods for Assigning Items to Slots for Efficient Access of the Items for Storage and Delivery

(71) Applicant: Charles Ray Grissom, Raleigh, NC (US)

(72) Inventor: Charles Ray Grissom, Raleigh, NC (US)

(73) Assignee: Optricity Corporation, Research Triangle Park, NC (US)

(21) Appl. No.: 13/772,649

(22) Filed: Feb. 21, 2013

Related U.S. Application Data
(60) Provisional application No. 61/609,554, filed on Mar. 12, 2012.
(60) Provisional application No. 61/602,209, filed on Feb. 23, 2012.

(51) Int. Cl. G06Q 10/06

(52) U.S. Cl. CPC G06Q 10/06315
USPC 705/7.25

(57) ABSTRACT

Techniques are described for assigning an item to a slot in an item storage facility. A first sorting technique is applied according to a specified item ordering criteria to arrange a plurality of items in a prioritized list of items. A second sorting technique is applied according to a specified slot ordering criteria to arrange a plurality of slots in a prioritized list of slots. A value cᵢ is calculated for each item in the prioritized list of items, wherein the value cᵢ represents the total number of available slots from the prioritized list of slots that the item can be successfully assigned to according to specified constraint rules. An item from the prioritized list of items is selected that has a smallest numeric value cₖ. A first slot from the prioritized list of slots is selected, wherein the selected item having the smallest numeric value cₖ meets specified constraints.

The present application claims the benefit of U.S. Provisional Application Ser. No. 61/602,209 entitled “Methods for Assigning Items to Slots for Efficient Access of the Items for Storage and Delivery” filed Feb. 23, 2012 and also the benefit of U.S. Provisional Application Ser. No. 61/609,554 entitled “Methods for Assigning Items to Slots for Efficient Access of the Items for Storage and Delivery” filed Mar. 12, 2012 both of which are assigned to the assignee hereof and hereby incorporated by reference herein in their entirety.

### CROSS REFERENCE TO RELATED APPLICATION

The patent application entitled “Systems and Methods for Efficiently Determining Item Slot Assignments”, U.S. application Ser. No. 12/392,182 filed on Feb. 25, 2009 now U.S. Pat. No. 8,234,004 has the same assignee as the present application, is a related application, and is hereby incorporated by reference in its entirety.

### FIELD OF THE DISCLOSURE

The present disclosure relates generally to the field of computerized placement and organization of items in a warehouse and more specifically to approaches for efficiently determining item slot assignments to improve the movement of items in a warehouse.

### BACKGROUND

Many products, such as food related products, beauty and fashion items, home, hardware and repair supplies, automobile related products, electronic products, such as televisions, radios, cell phones, personal computers (PCs), games and packaged PC software, and the like, after manufacturing, are generally moved to a distribution center or warehouse. A distribution center controls the flow of the various products from receiving to storage to shipping. For example, products are received and moved to storage locations termed slots, and selected products are then moved from their slots to placement in shipping containers to be sent to marketing endpoints, such as grocery stores, department stores, and the like. It can be appreciated that a haphazard method of storing products in a warehouse can lead to high costs due to inefficiencies in locating and moving the products. Further complicating the flow of products in a warehouse, is the varying demand for each product, such as experienced from an initial product introduction, through promotional and seasonal demands, to phase-out. A product's distribution cost is overhead that reduces profits and increases the price consumers must pay for the product.

A physical warehouse is generally built with shelf racks in various configurations with each shelf containing labeled locations, called slots, for item storage. Slots in a warehouse may also be identified by marking locations on a floor, radio frequency identification (RFID) tags, barcodes, or otherwise. Operations performed in a warehouse include, for example, assigning items to slots, storing items from a receiving dock into assigned slots, and retrieving items from assigned slots to a transport dock. Warehouse slotting systems generally exist to guide users as to where to place items in a warehouse. Prior systems base this guidance on matching an item to a storage location slot with respect to dimensional data, weight capacity data, general location in the warehouse, such as designated areas for high, medium, and low volume items, or the like. The common feature in these prior systems is the item to slot matching is generally done by considering the single item and candidate slot. Also, prior systems generally captured data related to product movement within a warehouse, but did not provide means for improving product flow beyond a mere visualization of current operations.

### SUMMARY

Among its several aspects, the present disclosure recognizes that providing more efficient methods for determining item slot assignments can reduce product distribution costs. To such ends, an embodiment of the invention addresses a computer based method for assigning an item to a slot in an item storage facility. A first sorting technique is applied according to a specified item ordering criteria to arrange a plurality of items in a prioritized list of items stored in a memory. A second sorting technique is applied according to a specified slot ordering criteria to arrange a plurality of slots in a prioritized list of slots stored in a memory. A value cᵢ is calculated for each item in the prioritized list of items, wherein the value cᵢ represents the total number of available slots from the prioritized list of slots that the item can be successfully assigned to according to specified constraint rules. An item from the prioritized list of items is selected that has a smallest numeric value cₖ as compared to the cᵢ values of the other items. A first slot is selected from the prioritized list of slots, wherein the selected item having the smallest numeric value cₖ meets specified constraints and is output as the selected first slot.

Another embodiment addresses a method for assigning an item to a slot in an item storage facility. A plurality of items is sorted according to an item ordering criteria into a prioritized list of items. A plurality of slots is sorted according to a slot ordering criteria into a prioritized list of slots. A value cᵢ is calculated for each item in the prioritized list of items, wherein cᵢ is a count of available slots that meet constraints for item Iᵢ. An item is selected from the prioritized list of items that has a value of cᵢ that is below a specified threshold, wherein the threshold is used to limit item selection to items that have an available slot count below the threshold to more likely preserve the original item priority. A first slot is selected from available slots, wherein the first slot meets the constraints for the selected item and the selected item is assigned to the selected first slot.

Another embodiment addresses a computer readable non-transitory medium having embodied thereon a program for assigning an item to a slot in an item storage facility, the program being executable by a computer. A plurality of items is sorted according to an item ordering criteria into a prioritized list of items. A plurality of slots is sorted according to a slot ordering criteria into a prioritized list of slots. A value cᵢ is calculated for each item in the prioritized list of items, wherein cᵢ is a count of available slots that meet constraints for item Iᵢ. An item is selected from the prioritized list of items that has a value of cᵢ that is below a specified threshold. A first slot is selected from available slots, wherein the first slot meets the constraints for the selected item.

A further embodiment addresses a method of assigning a prioritized sequence of items to a prioritized sequence of slots. Automatically adjusting priorities of items based on a count of available valid slots for each item as a count of available items varies, wherein the count of available valid slots is modified as items are assigned to slots. An override of an original item's priority is triggered for items which a current count of available valid slots falls below a threshold, wherein an item is selected based its current priority and assigned to a lower priority slot in order to hold a desired inventory count.

It is understood that other embodiments of the present invention will become readily apparent to those skilled in the art from the following detailed description, wherein various embodiments of the invention are shown and described by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Various aspects of the present invention are illustrated by way of example, and not by way of limitation, in the accompanying drawings, wherein:

FIG. 1A illustrates a system for efficiently assigning items to slots in accordance with the present invention;

FIG. 1B illustrates a warehouse racking showing items slotted on pallets;

FIG. 1C illustrates an exemplary slotting of an item using a forklift truck;

FIG. 1D illustrates a conveyor used to pack small items into shipping cartons for an outbound order;

FIG. 2A illustrates an exemplary item slot assignment process for priority reordering in accordance with the present invention;

FIG. 2B illustrates an example of item slot placement without using priority reordering in accordance with the present invention;

FIG. 2C illustrates an exemplary item slot placement result using priority reordering in accordance with the present invention; and

FIGS. 3A, 3B, and 3C illustrate a process for assigning items to slots in accordance with the present invention.

### DETAILED DESCRIPTION

The detailed description set forth below in connection with the appended drawings is intended as a description of various exemplary embodiments of the present invention and is not intended to represent the only embodiments in which the present invention may be practiced. The detailed description includes specific details for the purpose of providing a thorough understanding of the present invention. However, it will be apparent to those skilled in the art that the present invention may be practiced without these specific details. In some instances, well known structures and components are shown in block diagram form in order to avoid obscuring the concepts of the present invention.

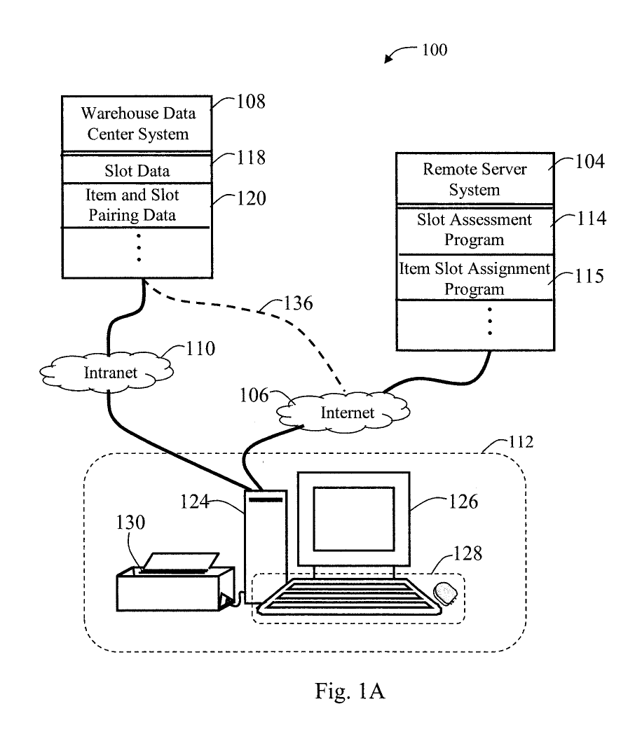

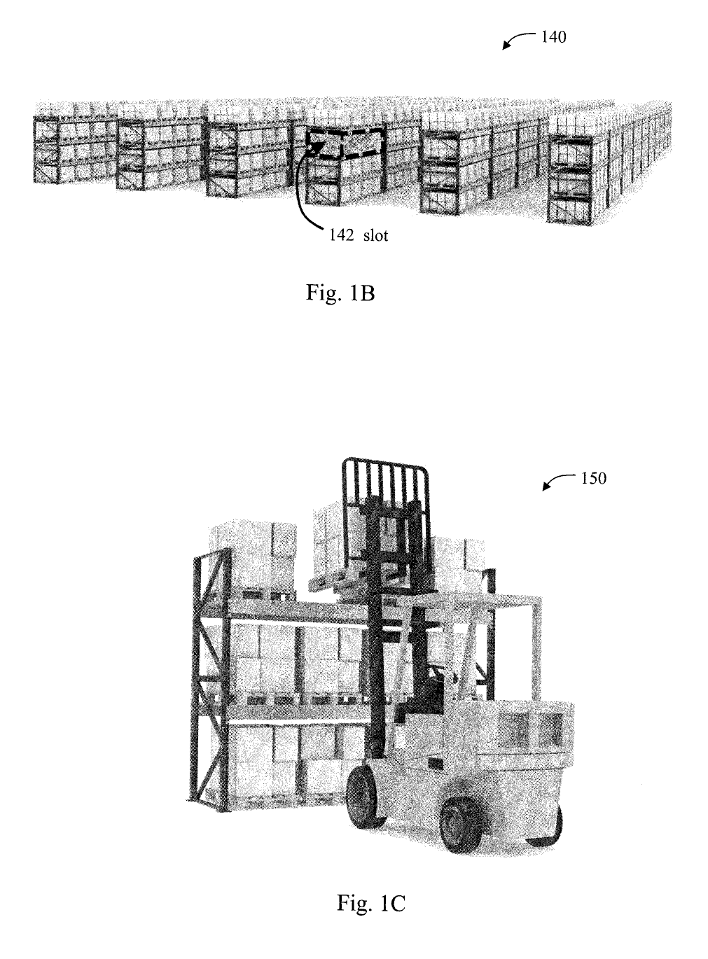

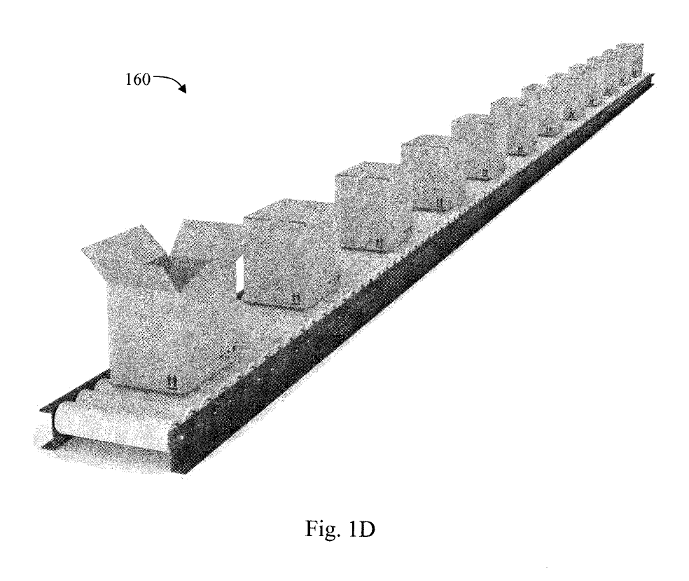

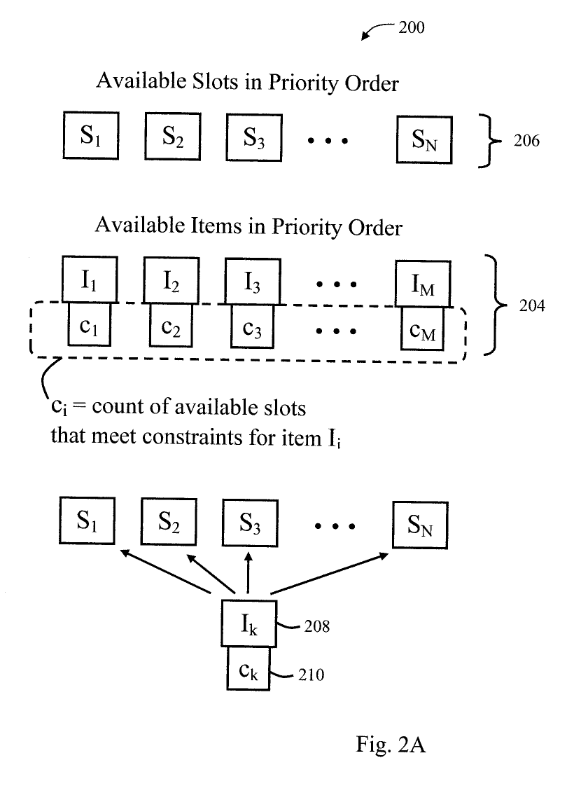

FIG. 1A illustrates a system 100 for efficiently determining item slot assignments in which an embodiment of the invention may be advantageously employed. The system 100 comprises a remote server system 104, the Internet 106, a warehouse data center system 108, an intranet 110, and a personal computing device 112, for example to be used in a warehouse including warehouse racking 140 shown in FIG. 1B for the placing of items in slots, such as slot 142, and distribution of the items to fill orders. The remote server system 104 stores, for example, a slot assessment program 114 and an item slot assignment program 115, both of which may be distributed to the personal computing device 112 over the Internet 106. The warehouse data center system 108 stores warehouse information, such as slot data 118 and item and slot pairing data 120, which may be downloaded to the personal computing device 112 over the intranet 110. The item and slot pairing data 120 may be converted to a list of item to slot assignments and translated to program steps in a language that controls robotic devices, such as a robotic controlled forklift truck 150 of FIG. 1C for example, associated with the physical warehouse. The personal computing device 112 comprises a central processing unit (CPU) and storage unit 124. Such personal computing device 112 also includes interface connections to the Internet 106 and the intranet 110, through a standard interface such as a universal serial bus (USB) or a standard wireless interface. The personal computing device 112 also includes a display 126, such as a monitor or touch screen, a keyboard and mouse 128, separate or integrated in the device, and a printer 130. It is noted that in an alternative embodiment, the warehouse data center system 108 may be located remote from the physical warehouse and connected to the personal computing device 112 through the Internet 106 utilizing an alternative path 136. While the personal computing device 112 is shown as a desktop system, embodiments of the invention may be suitably employed in any device, such as a server, a laptop computer, a tablet computer, or a smart phone, for example.

A physical warehouse is usually built with shelf racks, such as racking 140 of FIG. 1B, in various configurations with each shelf containing labeled storage locations called slots, such as the slot 142 for example, for item storage. A warehouse is considered a temporary repository for item stock. That is, a particular item, among the many that may be stored in the warehouse, usually has a notion of inbound and outbound flow which is generally, but not exclusively, expressed as a quantity per unit of time, giving a flow rate. For example, an item “I” may be subject to an outbound flow of 100 units per week. This flow rate is typically widely varying. For example, an item might have a seasonal variation in flow, such that for a particular period of time, it may flow faster or slower out of the warehouse due to varying demand from the warehouse customers. As an example, snow shovels may fly out of the warehouse in anticipation of or after a big snow storm, but may not move at all after a last snow storm of the season. The slots in the warehouse are storage spaces of varying characteristics that affect the flow rate. An outbound flow rate may be determined from monitoring item placement into shipping cartons for outbound orders as shown in conveyor system 160 of FIG. 1D.

For slotting analysis in accordance with this invention, the outbound flow of a single item is usually expressed as units per time period. That flow rate may represent a recent measurement, an average over a particular time period, such as a 13-period moving average of shipped units per period, a forecasted flow rate, or any other outbound flow rate and method of establishing an outbound flow rate for any particular item, and hence for the items stored in the warehouse. This flow rate for a single item can be used to determine a desired inventory level, number of units stored, for that item, by expressing the inventory in terms of a time period or a number of time periods. For example, an inventory level for a slot, or set of slots, may require the slot be able to hold one week's worth of inventory for a particular item. If the item in this example has an outbound flow rate of 20 units per day, then one weeks' worth of inventory would be 140 units. A desired inventory level can also be specified in different ways, such as an inventory level defined with or without respect to time periods or with or without respect to flow rate or based on a different metric.

Further, for the purposes of this invention, one of the considerations regards different desired inventory levels, so that in one embodiment the process described can make choices that allow the achievement of other goals in the assignment of items to slots. In particular, the process may consider a minimum inventory, a minimum number of units, a target inventory, and a maximum inventory. In an implementation of this invention, a minimum inventory is established as a constraint, such that any slot, or any set of slots, assigned to particular item must at least accommodate the minimum inventory unit count, subject to additional stacking and facing rules that may be established. This constraint then applies to and possibly reduces the number of slots cₖ that are counted as available for that particular item in a look ahead process. For example, an item may have a stacking limit based on crushability, and thus the slot the item is assigned to must accommodate the minimum inventory without exceeding the stacking limit. Also, an item may have a facing rule requirement based on restricting the amount of linear shelf space that is occupied by any one item or other consideration that may limit the number of stacking lanes due to facing requirements that a single item may occupy in the storage area.

The target inventory may be used to assign an item to a slot, or a set of slots, that among the slots that achieve the minimum inventory constraint, come closest to the target inventory count. For example, another slot in a priority sequence may be chosen rather than the next available slot based on a goal to achieve a target inventory count, due to physical or logical characteristics that enable the alternate slot or slots to store more inventory of the selected item. The maximum inventory count can be used in the assignment of an item to a slot, or a set of slots, among slots that satisfy the minimum inventory constraint and that exceed the maximum inventory constraint by the least amount. For example, another slot in a priority sequence may be chosen rather than the next available slot in order to make better use of space. This variation where the process skips slots in priority order to find the highest priority slot that does not exceed the maximum inventory count improves space utilization, at the expense of not adhering strictly to the priority sequence.

Similarly, inbound flow rates of an item may be established, and those rates used to assign slots such that the inbound inventory levels achieve the same goals as outbound flow rates. It is noted that both of these approaches of using inbound flow rates and outbound flow rates may be used simultaneously. That is, outbound flow rates establish inventory requirements for outbound slots, also referred to as pick slots, while inbound flow requirements are used for inbound slots, also referred to as reserve, or bulk storage slots. In particular, a single item may be slotted in two distinct ways in a warehouse. One set of slots used for picking and shipping outbound orders, while another set of slots is used for bulk storage, the reserve storage of inbound inventory. In such a case, the units of an item flow through the warehouse by moving from reserve slots to pick slots, as the pick slots are depleted of inventory by the picking and shipping process. An embodiment of the invention can be used to establish item-to-slot assignments for any such uses of slots, including multiple stages of reserve, bulk storage and forward, pick slots.

Additionally, the outbound shipment of items from a warehouse may be subject to relationships among items. This includes, but is not limited to, items that are often, or always, ordered together, a relationship that is noted as a shipping group. An example of a shipping group is fishing line and hooks. These items may be ordered and shipped independently, but there may also be a significant number of orders that include both items. In such a case, it is usually desirable to have these two items in outbound pick slots that are near each other in some measure.

Another example of a shipping group is a remote control toy car and batteries for the toy. These might generally be shipped together in any order that requires the toy car as a policy. Thus, it would be desirable to assign these items to slots very near each other, in some measure. It is also noted that some items, such as the batteries in the shipping group example above, may be assigned to multiple slots due to being included in multiple shipping groups. The minimum, target, and maximum inventories of units stored of this item may be applied to each shipping group individually, or as an aggregate over specified shipping groups, as an option.

Embodiments of the invention use such shipping groups, however they are determined, as input data to add constraints dynamically during the slotting process, so that the updated counts of available slots for items remaining to be slotted by the process affect the priority sequence of items and slots as described above. As an example, a constraint for a shipping group would be that all items in the shipping group must be within 50 feet of one another. Once one item in the shipping group is slotted by the standard slotting process, then the remaining items in the shipping group have the added constraint of being restricted to slots within 50 feet of the slot that was assigned to the first item in the shipping group. In many cases, this has the effect of reducing the count of available slots for those remaining items, and then they are handled as needed by the look-ahead process as described above.

In a warehouse, multiple items are usually picked in a single task, perhaps to fill an order or set of orders, such as the orders to fill a truck, or for delivery to a particular store or group of stores. The sequence of items to be picked on a path followed by a worker or machine can have a large influence on the productivity or efficiency of operations in the warehouse. For example, a goal could be to have higher volume items, in terms of units shipped, assigned to slots located earlier in a travel path, so that orders are more likely to be picked with shorter total travel distance. Another goal could be to have similar items separated by a specified distance, which would generally reduce picking errors. For example, a sports drink having many flavors that is packaged in similar looking cases except for a label may cause picking errors depending on placement. With many stacks of the sports drink that are placed in successive slots in a warehouse, it is very easy for a picker to pick a wrong flavor. By separating the various flavors at an appropriate distance, there is less chance of a picking error. Also, items that are often ordered together, such as washers and dryers, should be assigned in slots that are near each other to reduce the average dispersion for picking such orders. These criteria require consideration of nearby items when matching an item to a candidate slot. This is another example of how this invention adds constraints dynamically. In this case, when an item is slotted, all of the as-yet not slotted similar items are constrained to be in slots that are separated by a specified distance from the just-slotted item.

When items are assigned to slots in a warehouse, multiple goals may be considered together. For example, a first goal is to place items into slots in a desired sequence and a second goal is to assign items to slots in a manner that best utilizes available space in the slots and also adheres to any constraints that may exist for the slots. A third goal is to produce assignments for as many items to slots as possible. Such an assignment method that meets these exemplary goals may be implemented in an automatic computer program to guide the placement of items to slots.

Space utilization refers to the goal of best utilization of available space in the slots to minimize or eliminate wasted space. For example, wasted space may occur when a small item is placed into a large slot, or when the slot assigned to hold an item ends up holding far more inventory, as measured by unit count of that item, than is desired or necessary. Space utilization is measured by a number of methods as appropriate or as desired. Some criteria that indicate space utilization efficiency include a percentage of space used and a ratio of storable inventory in units of the item to desired number of units stored. Various methods may be used to produce these criteria or, more generally, a score associated with space utilization for a particular item is assigned to a particular slot or set of slots and the embodiments described below are exemplary embodiments of this invention that allow configuration and adaptability to different warehouse storage requirements and circumstances. Such scores corresponding to multiple assignments of the same item to any slot or to a set of slots are compared and ranked. A threshold may be utilized, such that any score not achieving the threshold is used to reject the associated assignment. Also, an upper limit may be utilized, such that any score above that limit is used to reject the associated assignment. This score may also be used to rank alternative assignments such that one assignment is chosen above another. More generally, an efficiency score may be calculated by an appropriate criteria, such that any two item assignments to different slots are compared based on that score, and one assignment is chosen above another based on results of such a comparison. These methods of measuring space utilization represent conditions such that the priority sequence of slots may be varied during the assignment process to improve space utilization, while limiting the variation from the established and preferred sequence.

Constraints refer to any stipulations that must be met by an assignment of an item to a slot. Example constraints include a weight limit, such as a total weight for a specified number of units in the slot, or a weight by unit and equipment requirements, such as sprinklers for flammable items. Further constraints include item similarity requirements, such as requiring that similar items not be placed next to each other in adjacent slots, item segregation requirements, such as requiring items of a certain type not be placed in a slot adjacent to an item of another certain type, and any other criteria that disallows a particular item from being assigned to or placed in a particular slot. Different constraints are chosen as appropriate for the product and slot configuration.

Sequencing refers to placing items in a desired sequence such as in decreasing or increasing order of activity, where activity refers to any measure of an item's flow into or out of its assigned slot, in the normal operation of the warehouse. For example, such measures include increasing or decreasing physical size, increasing or decreasing weight or density, increasing or decreasing number of items in a sequence of any product categorization codes, or any other method by which one may attribute an ordering to the items.

A significant number of operations performed in a warehouse include storing of items into assigned slots and removing of items from assigned slots. The slots in a warehouse may be assigned to be accessed in a desired sequence, such as an order of slots to be visited by a worker who picks items to fulfill a gathering task. For example, the order of slots may be specified by a rating system which ranks some slots above others in terms of efficiency, or the order of slots may be determined by equipment type, or any other order and sequencing method.

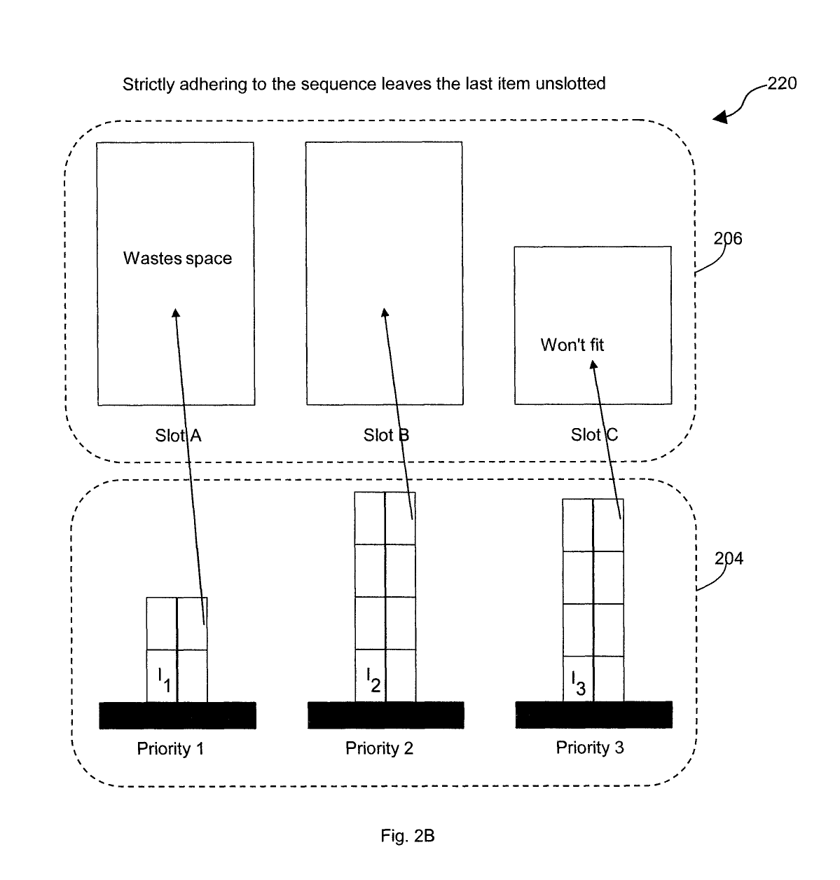

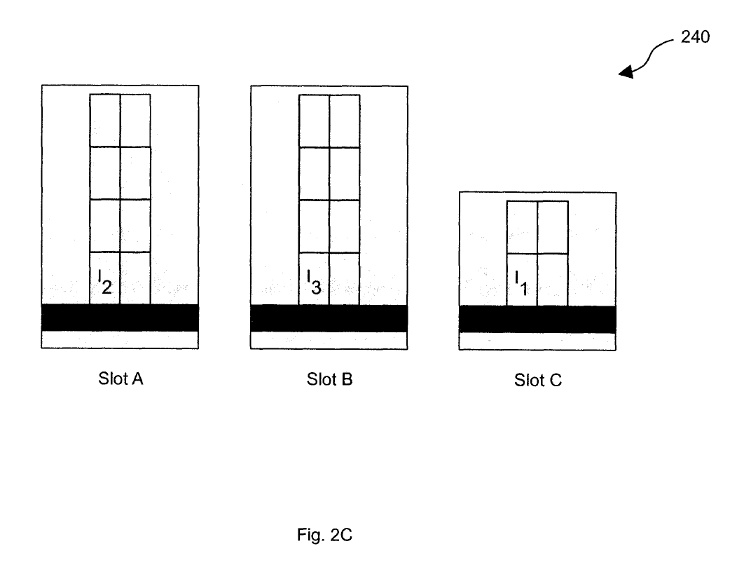

FIG. 2A illustrates an exemplary item slot assignment process 200 for priority reordering in accordance with the present invention. A method for assigning items to slots is described briefly in reference to FIG. 2A. In a first step, distinct items or item classes are arranged in a desired sequence, by applying a sorting technique using an associated desired ordering criteria, thus creating a prioritized list of items 204 that may be stored for example in the item and slot paring data 120 in the warehouse data center system 108. In a second step, the slots are arranged into any desired sequence, by applying a sorting technique using the desired ordering criteria, thus creating a prioritized list of slots 206 that may be stored for example in the item and slot paring data 120 in the warehouse data center system 108. Advantageously, in a third step, a look ahead function is provided. For each item or item class in the item priority list 204, compute a count cᵢ as the total number of available slots or slot categories from the priority list of slots 206 that the item can be successfully assigned to, by applying desired constraint rules. A look ahead process is used that prevents lower priority items from being orphaned without an available slot to be assigned to. Using this number of available slots for each item, choose an item Iₖ 208 from the item priority list 204 that has the smallest such number cₖ 210, breaking ties by the nominal priority that establishes the list. Advantageously, a threshold value T is used and an item Iₖ is chosen with the smallest value cₖ such that cₖ is also less than the threshold T. If no item Iₖ has cₖ less than T, then choose the next item Iₖ in the priority list, without regard to the numbers cₖ. The desired sequence is adhered to unless an item is running out of opportunities to be assigned to a slot. The threshold T addresses this situation and is usually determined in practice as a percentage of total slots. For example, if cₖ is less than five percent of the number of slots, then item Iₖ is at risk of being orphaned by the assignment process.

Items are sequenced in an order which is generally different than the count values associated with the items. For example, item A and item B might be sequenced such that item A is I₁ and item B is I₂, but c₁=5 and c₂=1. Thus in this case, item B can be ordered to jump ahead of item A, and hence be out of the desired sequence for items A and B. Such ordering represents a tradeoff of the sequence of items versus the slotting of the items. It is possible in the example above that if this reordering is not done, then item A might be assigned the only slot that item B could have been assigned to, leaving item B orphaned, or not slotted. Further, using the same example, suppose c₁=100, c₂=99, and the threshold T=10. In that case, item A, can be slotted not considering it a risk for item B, because the number c₂ did not fall below the threshold T=10, set to represent 10% of the total number of slots, which for this example is 100. So, the cₖ's in this case are not a primary consideration and the slotting process proceeds using only the priority ordering that says A comes before B. In another example, if c₂ were 9, then it falls below the threshold T=10, and item B would be assigned a slot ahead of A, due to the risk of B not getting assigned if the threshold T was not considered. Such use of a threshold comes into play more when there are thousands of items and slots of different sizes.

In a fourth step, take the item chosen in the third step and choose the first slot, or set of slots, where a single item or item class may be assigned to multiple slots for which the selected item meets the desired constraints. In an alternate embodiment, rather than choosing the first slot that matches with respect to the constraints, the process selects every slot Sᵢ that meets the constraints and then further ranks the selected slots by the assigned priority and thereby choose the highest ranking slot. The process continues to choose the second such slot, and then generally every such slot in priority order.

FIG. 2B illustrates an example of item slot placement 220 without using priority reordering in accordance with the present invention. In FIG. 2B, there are three items in priority order Iᵢ, I₂, and I₃ in priority item list 204 and three slots in priority order A, B, and C according to size in priority slot list 206. Of the three items the priority 1 item I₁ is small, and the priority 2 item I₂ and priority 3 item I₃ are large and the three slots A, B, C are arranged in slot priority order according to size with largest slots first followed by slots of decreasing size, such that slots A and B are large, while slot C is small. Strictly following the priority allocation would assign Item 1 to slot A, Item 2 to slot B, and attempt to assign Item 3 to slot C, where it fails to fit.

FIG. 2C illustrates an exemplary item slot placement result 240 using priority reordering in accordance with the present invention. The priority reordering process calculates that c₁=3 indicating that item I₁ can be placed in any of the three slots A, B, or C, c₂=2 indicating that item I₂ can only be placed in two of the three slots, and c₃=2 also indicating that item I₃ can only be placed in two of the three slots. By applying the reprioritization of this invention, item I₂ jumps ahead of item I₁ in the allocation sequence, so that item I₂ is assigned to slot A. Then, recalculating for the remaining items we have c₁=2 and c₃=1, so that item I₃ jumps ahead of item I₁ and is assigned to slot B. Finally, item I₁ is assigned to slot C. This allocation process respects the original priority sequences as much as possible, while still allocating each item to a slot that is valid with respect to constraints, such as, the constraint in this case which is size.

Continuing with the item slot assignment process 200, in a fifth step, among the slots chosen in the fourth step, compute a space utilization score, based on a desired measure of efficiency of use of space for the chosen item and the slot, or set of slots, in question. For example, a time period based on item shipping velocity may occur when the number of units for the chosen item that fit into a candidate slot exceeds a maximum inventory for that time period for the item. Use of the space utilization score helps avoid such a problem. Thus, slots having a space utilization score that falls outside of specified limits are rejected. Among the remaining slots, choose a slot, or set of slots, with the highest priority in the original priority list from step 2 that has a satisfactory space utilization score. The interpretation of satisfactory may mean a highest score, a lowest score, or a score within an acceptable range of values depending on the application.

In a sixth step, the item or item class according to the fourth step is assigned to the selected slot or set of slots according to the fifth step. In a seventh step, the item or item class according to the sixth step is removed from the priority list determined according to the first step, and the slot or set of slots is removed from the priority list determined according to the second step.

In an eighth step, the priority list of items is modified to move any remaining items that are also contained in shipping group to a higher priority if an item that was just assigned according to the sixth step is also contained in a shipping group or list of items. This modified priority list may be determined by using a numeric factor assigned to the shipping group, such as declaring that once any item of the shipping group is slotted, all remaining items in that group have their priority increased proportionally to that factor, if desired. In the eighth step, if any items remain in the priority list of items, and any slots remain in the priority list of slots, the process 200 returns to the third step and continues using the modified priority lists.

An embodiment of the invention addresses a method for assigning an item to a slot in an item storage facility. A first sorting technique is applied according to a specified item ordering criteria to arrange a plurality of items in a prioritized list of items. A second sorting technique is applied according to a specified slot ordering criteria to arrange a plurality of slots in a prioritized list of slots. A nominal assignment of items to slots then would proceed to assign item Iₖ to slot Sₖ, or set of slots starting with slot Sₖ, or more specifically, to assign the highest priority item to the highest priority slot, or set of slots, and proceed down the list of items in this manner, at every iteration, assigning the next highest priority item that is not already assigned to a slot, to the next highest priority slot that has available capacity for the item with respect to any constraints.

Such a priority reordering process allows for managed variance from a nominal assignment, so that goals of desired inventory levels and space utilization are addressed, as well as a goal of assigning every item to a slot or set of slots, while also respecting constraints that may prevent an item from being assigned to a particular slot. Examples of constraints include, but are not limited to: (1) defined areas or groups of slots that admit only a specified group of items, such as a fireproof area designed for flammable items; (2) slots that admit only a prescribed group of items due to physical position, such as a slot that does not allow heavy or fragile items due to height above the floor; (3) defined areas or groups of slots that admit only a prescribed group of items due to temperature, such as a freezer area; (4) defined types or sizes of slots that admit only a prescribed group of items due to velocity limits, such as roller flow slots that are used for faster moving shipping items; (5) defined areas or groups of slots reserved only for items of a certain characteristic, such as an area of slots designed for toxic items; or (6) more generally any defined area or group of slots or defined type or size of slot that is reserved for items with a specified characteristic.

To address the goal of assigning currently received items to slots, a look ahead feature is provided, so that items avoid getting orphaned or left with no possible assignments, because higher priority items have been assigned to the only available slot or set of slots for the lower priority item. This look ahead method allows the lower priority item to jump ahead in the assignment sequence when it appears that it is at risk of not having an available slot to be assigned to. To accomplish this look ahead feature, a value cᵢ is calculated for each item in the prioritized list of items, wherein the value cᵢ represents the total number of available slots from the prioritized list of slots that the item can be successfully assigned to according to specified constraint rules. An item from the prioritized list of items is selected that has a smallest numeric value cₖ. A first slot from the prioritized list of slots is selected, wherein the selected item having the smallest numeric value cₖ meets specified constraints.

### Pseudo Code for the Available Slot Counting:

For each item Iᵢ
set cᵢ to zero
For each slot still available
   if Iᵢ meets all constraints for this slot, add 1 to cᵢ

In this manner, the procedure varies from the nominal priority sequence of items in order to attempt to accomplish the goal of slotting every item. Similarly, the process can allow variance from the nominal priority list of available slots by skipping slots or sets of slots in the sequence that do not achieve the desired target inventory, unit count per slot, or that permit exceeding of the maximum inventory unit count.

In an alternate embodiment, a second score that is calculated for an item and slot pairing from the patent application entitled “Systems and Methods for Efficiently Determining Item Slot Assignments”, U.S. application Ser. No. 12/392,182 filed on Feb. 25, 2009 may be used to select among the valid slots that are scanned for the item being slotted. In another embodiment, both the space utilization score and the second score may be used, where either score may act as a tie breaker in the slotting process. The second score may lead to a strict ordering of the items according to the sequence criteria that is used to define the score. But, the strict ordering may be relaxed just enough to improve space utilization. For example, decreasing velocity, representing units shipped per week, may be generally used as the sequencing criteria for items, but is not applied in a particular circumstance to avoid placing a tiny fast moving item into a large slot. The space utilization score represents a criteria that forces an item to jump out of score sequence, but just enough to reach the threshold space utilization value. An exemplary space utilization score may be calculated as follows;
Let item I be assigned to slot S, such that V₁ is the cubic volume occupied by the maximum inventory of item I that physically fits into slot S. Let V_{S} be the cubic volume available in slot S. Then the space utilization score is U=V₁/V_{S}

Pseudo Code for Space Utilization Variation of Priority Sequencing:
1. Given item Iᵢ as the next item to be slotted
2. From the prioritized list of available slots choose the next available slot Sₖ
3. If Sₖ does not satisfy the constraints with respect to item Iᵢ, go back to 2
4. Let Sₖ be the temporary candidate slot S_{c}
5. If S_{c} meets the space utilization score threshold, then assign item Iᵢ to slot S_{c}
6. Else, from the remaining available slots in priority order, choose the next available slot Sₙ
7. If no further slots are available, assign item Iᵢ to slot S_{c}
8. If Sₙ meets the space utilization score threshold, then assign Iᵢ to Sₙ, else go back to 6.

In more detail, items are usually stored in warehouse slots in the form of one or more of the following storage units:
1. caches (single occurrences of an item);
2. inner packs (packages containing two or more eaches);
3. cases (packages containing two or more eaches or inner packs);
4. pallets (portable platforms constructed of plastic, wooden, metal or other material) with two or more cases or other packages/cartons of items stacked on top; or
5. any other type of storage unit.

The slots, representing storage locations or positions on shelves, are considered to have one or more orderings, representing a sequence of operations, determined in various ways, including, but not limited to:
1. determining a path or travel path sequence, which includes floor travel path, rack sequence, slot sequence within a rack, such as z-pick, quad pick, and others;
2. determining slot ratings with respect to distance from the floor or the end of an aisle, considered a golden zone;
3. determining slot ratings based on proximity to certain other warehouse areas or features, such as loading or unloading docks;
4. determining slot sequences with respect to automation equipment configuration, such as conveyor belts or other transport systems;
5. determining slot sequences with respect to warehouse infrastructure or equipment construction or layout; or
6. any other sequencing criteria.

Each independent area of a warehouse requires one or more such sequences for efficient operation. For the purposes of the measurements described in this invention, the measurements are described for a single such ordering, but generally apply to every slot sequence.

The collection of items to be placed in slots can also be assigned ideal or preferred item sequences, usually with respect to the slot sequence. These item sequences are determined according to a characteristic or characteristics of the items and slots and include but are not limited to:
1. item storage unit weight decreasing or increasing;
2. item storage unit height increasing or decreasing;
3. item storage unit density increasing or decreasing;
4. items sequenced by code number or category;
5. items sequenced by vendor or product type;
6. items sequenced by sales or shipping frequency;
7. items sequenced by unit volume;
8. items sequenced by volume of movement into or out of the warehouse over time, quantified as velocity; or
9. items sequenced by any other means.
   Any number of combinations can be applied to produce a single preferred item sequence. For example, items may be sequenced in alphabetical order by category, and for items with the same category, in decreasing order of unit density, and then for items with the same unit density, in decreasing order of unit height. Applying this rule produces a strict sequence of items I₁, I₂, . . . , I_{N}.

Once a preferred item sequence has been determined, that sequence can be used to determine an ordering for any two items in the sequence. That is, given item A and item B, then item A comes before item B if the position of item A in the sequence is prior to the position of item B in the sequence, and item A comes after item B if the position of item A in the sequence comes after the position of item B.

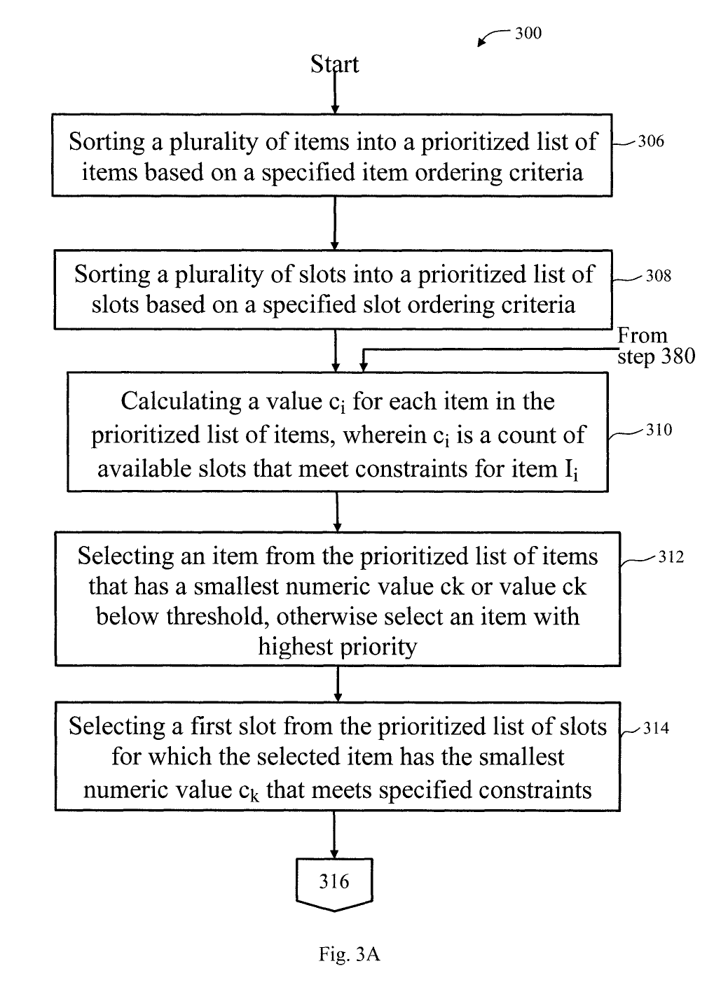

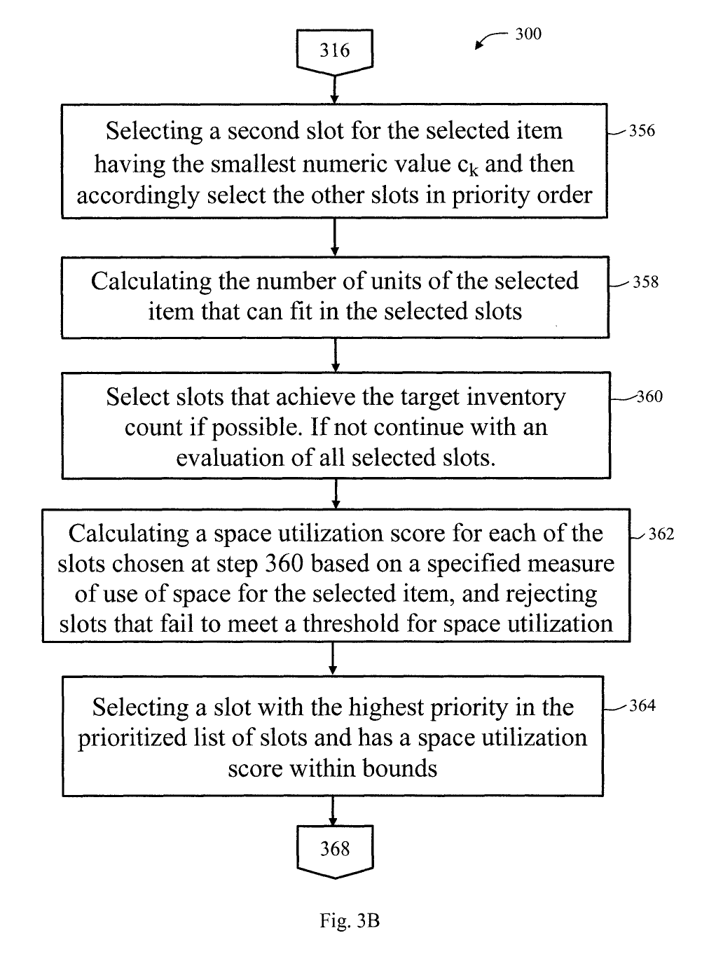

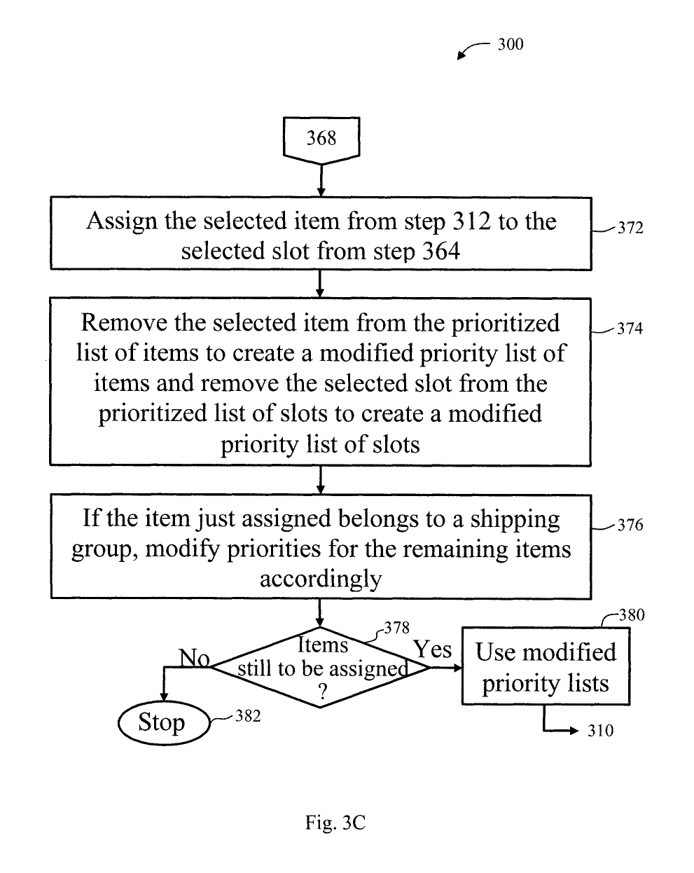

Similarly, a preferred slot sequence allows the ordering of any two slots to be determined. Given any preferred slot sequence, and any preferred item sequence, the assignment method described below in connection with the discussion of FIGS. 3A-3C may be applied. FIGS. 3A-3C illustrate a process 300 for assigning items to slots in accordance with the present invention.

Beginning the process 300 at step 306 in FIG. 3A, the distinct items, or item classes, are arranged in a desired sequence, by applying a sorting technique using a desired item ordering criteria, thus creating a prioritized list of items, such as the exemplary item priority list 204 shown above. For example, priority is determined from a sorted list of items in a desired sequence, where the first item in the list is considered the highest priority. One example of priority ordering of items is sequencing items in decreasing order of velocity, usually item movement per week or picks per week, or for any relevant time period.

At step 308, the slots are arranged into a desired sequence, by applying a sorting technique using a desired slot ordering criteria, thus creating a prioritized list of slots such as the slot priority list 206 shown above. An example of priority ordering of slots is sequencing slots in a pick path order so that the first slot in the pick path is the highest priority slot in the slot sequencing.

At step 310, for each item or item class in the item priority list, the total number of available slots or slot categories from the priority list of slots that the item can be successfully assigned to is calculated by applying desired constraint rules as described above with regard to the “Pseudo code for the available slot counting”. Example constraint rules include a requirement that the slot, or slots, chosen are sized large enough to hold a desired minimum inventory unit count, with respect to stacking and facing rules for the item or the slot, weight limits by height from the floor, such as not placing heavy items on overhead shelves, and slots that are covered by sprinklers and hence must be used for flammable items.

At step 312, an item is selected from the priority list that has the smallest calculated number of available slots for each item such as the item with the smallest numeric value cₖ or the item with a cₖ below a threshold, where the item priority sequence is used to break any encountered ties. For example, among items with the same lowest value for cₖ, choose the item with the highest priority.

At step 314, for the item chosen at step 312, select a first slot or set of slots, where a single item or item class may be assigned to multiple slots, for which the selected item meets the desired constraints. The process 300 continues through connecting point 316 to step 356 in FIG. 3B.

At step 356 in FIG. 3B, a second slot is selected for the selected item having the smallest numeric value cₖ and then generally every such slots in priority order. At step 358, the number of units of the selected item that can fit in the selected slots is calculated.

At step 360, slots are selected that achieve the target inventory count, if possible. If achieving the target inventory count is not possible, the process continues to step 362 with an evaluation of the available selected slots with respect to achieving a minimum inventory. In an alternative embodiment, the item search and slot search are performed in parallel to avoid a repeated search for slots achieving minimum inventory if the target inventory search fails.

At step 362, for each of the slots chosen at step 360, a space utilization score is calculated, based on the desired measure of efficiency of use of space for the chosen item and the slot or set of slots in question. For example, a space utilization score may include calculating a volume, such as a cubic volume, of the maximum inventory of units of a selected item that can be fit into a selected slot, divided by the desired target inventory of units of that item. In this exemplary case, values over 1.0 might cause the selected slot to be rejected because such slots hold too much inventory, and such slots should be used for items that need more space for the minimum or target inventory, if possible. For example, a slot may hold 1000 units of a small item that requires only 100 units of space to meet its target inventory, which would be a waste of space, and the same slot may hold 20 units of a larger item that may require 20 units as the target inventory. Thus, any slot having a space utilization score that falls outside of specified limits is advantageously rejected from being selected for item placement. For example, the space utilization score may be used to avoid putting items into a slot that holds too much inventory, and thus avoids having the inventory sit in the slot too long, with respect to the product flow out of the warehouse. Step 362 generally reduces the slots being considered by rejecting any slot that violates the space utilization threshold. It is possible that no slot is rejected, some slots are rejected, or even all slots are rejected.

At step 364, among the remaining slots, choose the slot or set of slots with highest priority in the original priority list at step 308 that also has a satisfactory score, wherein satisfactory for example is defined as the highest score among the remaining slots, or a score is within an acceptable range of values. In the example of a max inventory cube/target inventory cube, a lower score is more desirable, so a satisfactory score in that case is a reciprocal value. Alternatively, a space utilization goal may be more appropriate, such as percentage utilization of the available space in the slot by target inventory count of the item, in which case a higher score is more desirable. Alternatively, a sequencing goal may be more appropriate in order to improve labor productivity or in order to build stable outbound shipments, by for example, sequencing items such that heavier or denser ones are earlier in the sequence, in which case the highest priority slot with acceptable space utilization and having a score in a range of acceptable values, may be selected. A user of the slot assignment system may choose which focus is more desirable or a default set of goals, such as sequencing items by decreasing shipping velocity and sequencing slots by a warehouse pick sequence, may be used as a preset priority. The process 300 continues through connecting point 368 to step 372 in FIG. 3C.

FIG. 3C illustrates automatically adjusting priorities of items based on a count of available slots for each item as a count of available items varies, wherein the count of available slots is modified as items are assigned to slots. An override of an original item's priority is triggered for items for which a current count of available valid slots (slots that meet all constraints for the item) falls below a threshold, as described with regard to step 312, wherein an item is selected based its current priority and assigned to a lower priority slot in order to hold a desired inventory count.

At step 372 in FIG. 3C, the selected item or item class from step 312 is assigned to the slot or set of slots from step 364. At step 374, the selected item or item class from step 312 is removed from the prioritized list of items from step 306 to create a modified priority list of items, and the slot or set of slots from step 364 is removed from the priority list from step 308 to create a modified priority list of slots. At step 376, if the item just assigned at step 372 belongs to a shipping group, the priorities for the remaining items are modified accordingly.

At step 378, a determination is made whether any items remain in the priority list of items and any slots remain in the priority list of slots. At step 380, if there are items still to be assigned, the process 300 returns to step 310, using the modified priority lists from step 374. If there are no further items to be assigned, the process stops at step 382.

After completion of step 378 for the last time, this process 300 has produced a listing of item-to-slot assignments for as many items as possible. This process of FIGS. 3A-3C, produces an optimized solution to the item slotting problem, such that the goals are achieved to a high degree and all constraints are met

The embodiments of the present invention may be programmed in a computing device, such as the computer 112 of FIG. 1A, a desk top, a laptop, a tablet, a smart phone, or the like to accept an input list of items or item classes, warehouse slot storage locations, such as associated with racking 140 of FIG. 1B, and rules or criteria for item and slot sequencing and their associated constraints, and produce a list of item to slot assignments, such that this list can be used to perform the physical storage of items to slots in a physical warehouse. The list of item to slot assignments may be translated to program steps in a language that controls robotic devices, such as the robotic controlled forklift truck 150 of FIG. 1C for example, associated with the physical warehouse. It is noted that a robotic forklift may also be human controlled and the list of item to slot assignments may also be translated to a human readable list for manual placement of items. Computer program code or “program code” for being operated upon or for carrying out operations according to the teachings of the invention may be initially written in a high level programming language such as C, C++, JAVA®, Smalltalk, JavaScript®, Visual Basic®, TSQL, Perl, or in various other programming languages. A program written in one of these languages is compiled to a target processor architecture by converting the high level program code into a native assembler program. Programs for the target processor architecture may also be written directly in the native assembler language. A native assembler program uses instruction mnemonic representations of machine level binary instructions specified in a native instruction format, such as a 32-bit native instruction format. Program code or computer readable non-transitory medium as used herein refers to machine language code such as object code whose format is understandable by a processor.

A computer such as the computer 112 of FIG. 1A, for example, may be configured to execute a program stored as non-transitory signals on a computer readable storage medium either directly associated locally with the processor, such as may be available through a local storage medium or may be accessible through the Internet 106, for example, from a remote server system, such as remote server system 104, or over an intranet 110. The methods described in connection with the embodiments disclosed herein may be embodied in a computer system using software accessed from a memory module that stores non-transitory signals executed by the processor. The software module may reside in random access memory (RAM), flash memory, read only memory (ROM), electrically programmable read only memory (EPROM), hard disk, a removable disk, tape, compact disk read only memory (CD-ROM), or any other form of non-transitory storage medium known in the art. A non-transitory storage medium may be coupled to the processor such that the processor can read information from, and in some cases write information to, the storage medium. The storage medium coupling to the processor may be a direct coupling integral to a circuit implementation or may utilize one or more interfaces, supporting direct accesses or data streaming using down loading techniques.

While the invention is disclosed in the context of illustrative embodiments for use in warehouses or distribution centers it will be recognized that a wide variety of implementations may be employed by persons of ordinary skill in the art consistent with the above discussion and the claims which follow below. In one example implementation, the various processes may be scripted into a general purpose calculation program, such as a spreadsheet program.

What is claimed is:

1. A computer based method for assigning an item to a slot in an item storage facility, the method comprising:
applying a first sorting technique according to a specified item ordering criteria to arrange a plurality of items in a prioritized list of items stored in a memory;
applying a second sorting technique according to a specified slot ordering criteria to arrange a plurality of slots in a prioritized list of slots stored in a memory;
calculating a value cᵢ for each item in the prioritized list of items, wherein the value cᵢ represents a total number of available slots from the prioritized list of slots that the item can be successfully assigned to according to specified constraint rules;
selecting an item from the prioritized list of items that has a smallest numeric value cₖ as compared to the cᵢ values of the other items; and
selecting a first slot from the prioritized list of slots, wherein the selected item having the smallest numeric value cₖ meets specified constraints and is output as the selected first slot.

2. The method of claim 1, wherein the selecting first slot step further comprises:
selecting the slots that meet the constraints;
ranking the selected slots by a score; and
choosing the highest ranking slot.

3. The method of claim 1 further comprising:
selecting a second slot for the selected item having the smallest numeric value cₖ and then accordingly the other slots are selected in priority order;
calculating a space utilization score for each of the associated slots based on a specified measure of use of space for the selected item; and
selecting a slot with the highest priority in the prioritized list of slots and has a space utilization score higher than other slots.

4. A method for assigning an item to a slot in an item storage facility, the method comprising:
sorting a plurality of items according to an item ordering criteria into a prioritized list of items;
sorting a plurality of slots according to a slot ordering criteria into a prioritized list of slots;
calculating a value cᵢ for each item in the prioritized list of items, wherein cᵢ is a count of available slots that meet constraints for item Iᵢ;
selecting an item from the prioritized list of items that has a value of cᵢ that is below a specified threshold, wherein the threshold is used to limit item selection to items that have an available slot count below the threshold to more likely preserve the original item priority; and
selecting a first slot from available slots, wherein the first slot meets the constraints for the selected item and the selected item is assigned to the selected first slot.

5. The method of claim 4 further comprising:
selecting a second slot from remaining available slots, wherein the second slot meets the constraints for the selected item; and
selecting other slots in a priority order from the remaining slots.

6. The method of claim 5 further comprising:
calculating a space utilization score for each of the slots in priority order based on a specified measure of use of space for the selected item; and
selecting a slot with the highest priority in the slots in priority order and that has a space utilization score higher than other slots in the slots in priority order as a placement slot, wherein the selected item is placed in the placement slot.

7. The method of claim 4 further comprising;
selecting a placement slot that meets the constraints of the selected item and has a space utilization score higher than remaining available slots, wherein the selected item is placed in the placement slot;
removing the selected item from the prioritized list of items and the placement slot from the prioritized list of slots; and
selecting a second placement slot that meets the constraints of a selected second item and has a space utilization score higher than a second set of remaining available slots, wherein the selected second item is placed in the second placement slot.

8. The method of claim 7 further comprising:
determining further placement slots for remaining items by removing a selected slot and item from a previous priority list of slots and items, wherein each placement slot meets the constraints of a selected remaining item and has a space utilization score higher than each succeeding set of remaining available slots and wherein each selected item is placed in a selected remaining slot.

9. A computer readable non-transitory medium having embodied thereon a program for assigning an item to a slot in an item storage facility, the program being executable by a computer to perform the steps of:
sorting a plurality of items according to an item ordering criteria into a prioritized list of items;
sorting a plurality of slots according to a slot ordering criteria into a prioritized list of slots;
calculating a value cᵢ for each item in the prioritized list of items, wherein cᵢ is a count of available slots that meet constraints for item Iᵢ;
selecting an item from the prioritized list of items that has a value of cᵢ that is below a specified threshold; and
selecting a first slot from available slots, wherein the first slot meets the constraints for the selected item.

10. The computer readable non-transitory medium of claim 9 further comprising:
selecting a second slot from remaining available slots, wherein the second slot meets the constraints for the selected item; and
selecting other slots in a priority order from the remaining slots.

11. The computer readable non-transitory medium of claim 10 further comprising:
calculating a space utilization score for each of the slots in priority order based on a specified measure of use of space for the selected item; and
selecting a slot with the highest priority in the slots in priority order and that has a space utilization score higher than other slots in the slots in priority order as a placement slot, wherein the selected item is placed in the placement slot.

12. The computer readable non-transitory medium of claim 9 further comprising;
selecting a placement slot that meets the constraints of the selected item and has a space utilization score higher than remaining available slots, wherein the selected item is placed in the placement slot;
removing the selected item from the prioritized list of items and the placement slot from the prioritized list of slots; and
selecting a second placement slot that meets the constraints of a selected second item and has a space utilization score higher than a second set of remaining available slots, wherein the selected second item is placed in the second placement slot.

13. The computer readable non-transitory medium of claim 12 further comprising:
determining further placement slots for remaining items by removing a selected slot and item from a previous priority list of slots and items, wherein each placement slot meets the constraints of a selected remaining item and has a space utilization score higher than each succeeding set of remaining available slots and wherein each selected item is placed in a selected remaining slot.

14. A method of assigning a prioritized sequence of items to a prioritized sequence of slots, the method comprising:
automatically adjusting priorities of items based on a count of available valid slots for each item as a count of available items varies, wherein the count of available valid slots is modified as items are assigned to slots; and
triggering an override of an original item's priority for items which a current count of available valid slots falls below a threshold, wherein an item is selected based its current priority and assigned to a lower priority slot in order to hold a desired inventory count.

15. The method of claim 14 further comprising:
adjusting a priority for a slot based on the slots' capacity to hold a desired target inventory of an item being slotted.

16. The method of claim 14 further comprising:
adjusting a priority for a slot based on space utilization of a desired target inventory of an item being slotted, wherein the item is assigned to a lower priority slot based on a space utilization threshold.

17. The method of claim 14 further comprising:
adjusting priority of items when an item from an identified shipping group is slotted, wherein other items in the shipping group are slotted with a higher priority and with user specified proximity rules with respect to all items in the shipping group.

18. The method of claim 14 further comprising:
adjusting the priority of items when an item from an identified association rule is slotted, wherein other associated items are slotted with a higher priority and with user specified proximity rules with respect to all associated items in the identified association rule.

19. The method of claim 14, wherein the count of available valid slots represents a total number of available slots from the prioritized list of slots that the item can be successfully assigned to according to specified constraint rules

20. The method of claim 14, further comprising:
calculating a space utilization score for each of the slots based on a specific measure of use of space for the selected item; and
selecting a slot with the highest priority in a prioritized list of slots and has a space utilization score within bounds.
